(19) United States
(12) Patent Application Publication
(10) Pub. No.: US 2025/0059988 A1
(43) Pub. Date: Feb. 20, 2025

(54) Linear Actuator Arrangement for an Amusement Activity Station

(71) Applicant: Diggerland USA, LLC, West Berlin, NJ (US)

(72) Inventors: Ilya Girlya, West Berlin, NJ (US); Yan Girlya, West Berlin, NJ (US)

(21) Appl. No.: 18/885,121

(22) Filed: Oct. 1, 2024

Related U.S. Application Data
(63) Continuation-in-part of application No. 17/738,468, filed on May 6, 2022.
(63) Continuation-in-part of application No. 29/955,169, filed on Jul. 31, 2024.

(51) Int. Cl. F15B 15/06; F15B 15/14; F16H 21/40

(52) U.S. Cl. CPC F15B 15/06; F15B 15/14; F16H 21/40

(57) ABSTRACT

A linear actuator arrangement for an amusement activity station includes a linear actuator, an actuator anchor, and a movable member. The linear actuator has an anchor end, a displacement end, and a main actuator axis extending therethrough. The actuator anchor is attached to the anchor end thereby fixing a first axis of rotation extending through the anchor end orthogonal to the main actuator axis in parallel relation to a reference plane. The movable member has a main member axis extending parallel to the reference plane. The displacement end is coupled to the movable member for directing the movable member along a movable member path intermediate fully extended and fully retracted configurations. The displacement end has a second axis of rotation extending orthogonally relative to the main actuator axis in parallel relation to the reference plane and is translatable along the movable member path.

### PRIOR HISTORY

This application is a Continuation-in-Part patent application claiming the benefit of U.S. patent application Ser. No. 17/738,468 filed in the United States Patent and trademark Office (USPTO) on 6 May 2022 and US Design patent application Ser. No. 29/955,169 filed in the USPTO on 31 Jul. 2024.

### FIELD OF THE PRESENTLY DISCLOSED SUBJECT MATTER

The presently disclosed subject matter generally relates to a linear actuator arrangement. More particularly, the presently disclosed subject matter relates to a linear actuator arrangement for use with amusement activity station to actuate portions of the amusement activity station during use thereof by user participants.

### GENERAL DESCRIPTION

There is provided in accordance with a first aspect of the presently disclosed subject matter a linear actuator arrangement for an amusement activity station. In some embodiments, the linear actuator arrangement comprises a linear actuator, an actuator anchor, and a movable member. In some embodiments, the linear actuator comprises a main actuator body, a rod, an anchor end, a displacement end, a main actuator axis, and a power mechanism. The main actuator axis extends through the rod, the anchor end and displacement end. The power mechanism selectively actuates the rod intermediate a fully extended configuration and a fully retracted configuration relative to the main actuator body.

The actuator anchor is attached to the anchor end thereby fixing a first axis of rotation extending through the anchor end orthogonal to the main actuator axis in parallel relation to a reference plane. The movable member comprises a main member axis extending parallel to the reference plane. The displacement end is coupled to the movable member for directing the movable member along a movable member path intermediate the fully extended and fully retracted configurations. The displacement end comprises a second axis of rotation extending orthogonally relative to the main actuator axis in parallel relation to the reference plane and translatable along the movable member path.

In some embodiments, the fully extended configuration obliquely angles the main actuator axis relative to the reference plane at a first oblique angle and the fully retracted configuration obliquely angles the main actuator axis to the reference plane at a second oblique angle greater than the first oblique angle. In some embodiments, the movable member path is arcuate such that the displacement end moves through an arc length. In some embodiments, the arc length comprises an arc length high point, the arc length high point being maximally distanced from the reference plane such that a partially extended configuration of the rod relative to the main actuator body obliquely angles the main actuator axis relative to the reference plane at a third oblique angle, the third oblique angle being greater than second oblique angle.

In some embodiments, the linear actuator comprises a motor housing and a gear box attached to the motor housing and the main actuator body. In some embodiments, the motor housing comprises a main housing axis extending in parallel relation to the main actuator axis. In some embodiments, the main housing axis extends in parallel relation to the main actuator axis such that the main actuator axis extends intermediate the main housing axis and the reference plane. In some embodiments, the displacement end extends from the gear box and the anchor end is defined by a rod end of the rod. In some embodiments, the displacement end is defined by the rod end of the rod and the anchor end extends from the gear box.

In some embodiments, the movable member is linked to a reset mechanism of the amusement activity station. In some embodiments, the fully retracted configuration is operable to reset the amusement activity station, and the fully extended configuration enables reset use of the amusement activity station. In some embodiments, the movable member is linked to an anchor member of the amusement activity station by at least one linkage member. The linkage member has a linkage end, which linkage end is translatable along the movable member path.

There is provided in accordance with another aspect of the presently disclosed subject matter a linear actuator arrangement for an amusement activity station. In some embodiments, the linear actuator arrangement comprises a linear actuator and actuator anchor. In some embodiments, the linear actuator comprises a main actuator body, a rod, an anchor end, a displacement end, and a main actuator axis. The main actuator axis extends through the rod, the anchor end and displacement end. The rod is actuable intermediate a fully extended configuration and a fully retracted configuration relative to the main actuator body.

The actuator anchor is attached to the anchor end thereby fixing a first axis of rotation extending through the anchor end orthogonal to the main actuator axis in parallel relation to a reference plane. The displacement end is coupled to the movable member of the amusement activity station for directing the movable member along a movable member path intermediate the fully extended and fully retracted configurations. The displacement end comprises a second axis of rotation extending orthogonally relative to the main actuator axis in parallel relation to the reference plane and translatable along the movable member path.

In some embodiments, the fully extended configuration obliquely angles the main actuator axis relative to the reference plane at a first oblique angle and the fully retracted configuration obliquely angles the main actuator axis to the reference plane at a second oblique angle greater than the first oblique angle. In some embodiments, the movable member path is arcuate such that the displacement end moves through an arc length. In some embodiments, the arc length comprises an arc length high point, the arc length high point being maximally distanced from the reference plane such that a partially extended configuration of the rod relative to the main actuator body obliquely angles the main actuator axis relative to the reference plane at a third oblique angle, the third oblique angle being greater than second oblique angle.

In some embodiments, the linear actuator comprises a motor housing and a gear box attached to the motor housing and the main actuator body. In some embodiments, the motor housing comprises a main housing axis extending in parallel relation to the main actuator axis. In some embodiments, the main housing axis extends in parallel relation to the main actuator axis such that the main actuator axis extends intermediate the main housing axis and the reference plane. In some embodiments, the displacement end extends from the gear box and the anchor end is defined by a rod end of the rod. In some embodiments, the displacement end is defined by the rod end of the rod and the anchor end extends from the gear box.

In some embodiments, the movable member is linked to a reset mechanism of the amusement activity station. In some embodiments, the fully retracted configuration is operable to reset the amusement activity station, and the fully extended configuration enables reset use of the amusement activity station. In some embodiments, the movable member is linked to an anchor member of the amusement activity station by at least one linkage member. The linkage member has a linkage end, which linkage end is translatable along the movable member path.

### BRIEF DESCRIPTIONS OF THE DRAWINGS

Other features and objectives of the presently disclosed subject matter will become more evident from a consideration of the following brief descriptions of patent drawings.

FIG. 1 is a first sequential side view of a linear actuator according to the presently disclosed subject matter shown in a fully extended configuration such that a main actuator axis of the linear actuator extends at a first oblique angle relative to a reference plane and a rod end of the linear actuator is positioned at an anchor end of the linear actuator.

FIG. 2 is a second sequential side view of the linear actuator otherwise depicted in FIG. 1 shown being directed into a partially retracted configuration such that the main actuator axis of the linear actuator extends at a second oblique angle relative to the reference plane, the second oblique angle being greater than the first oblique angle.

FIG. 3 is a third sequential side view of the linear actuator otherwise depicted in FIG. 2 shown in a fully retracted configuration such that the main actuator axis of the linear actuator extends at a third oblique angle relative to the reference plane, the third oblique angle less than the first oblique angle and greater than the first oblique angle.

FIG. 4 is a fourth sequential side view of the linear actuator otherwise depicted in FIG. 3 shown being directed into a partially extended configuration such that the main actuator axis of the linear actuator extends at the second oblique angle relative to the reference plane.

FIG. 5 is a fifth sequential side view of the linear actuator otherwise depicted in FIG. 4 shown being directed into the fully extended configuration such that the main actuator axis of the linear actuator extends at the first oblique angle relative to the reference plane.

FIG. 6 is a first sequential side view of a linear actuator according to the presently disclosed subject matter shown in a fully extended configuration such that a main actuator axis of the linear actuator extends at a first oblique angle relative to a reference plane and a rod end of the linear actuator is positioned at a displacement end of the linear actuator.

FIG. 7 is a second sequential side view of the linear actuator otherwise depicted in FIG. 6 shown being directed into a partially retracted configuration such that the main actuator axis of the linear actuator extends at a second oblique angle relative to the reference plane, the second oblique angle being greater than the first oblique angle.

FIG. 8 is a third sequential side view of the linear actuator otherwise depicted in FIG. 7 shown in a fully retracted configuration such that the main actuator axis of the linear actuator extends at a third oblique angle relative to the reference plane, the third oblique angle less than the first oblique angle and greater than the first oblique angle.

FIG. 9 is a fourth sequential side view of the linear actuator otherwise depicted in FIG. 8 shown being directed into a partially extended configuration such that the main actuator axis of the linear actuator extends at the second oblique angle relative to the reference plane.

FIG. 10 is a fifth sequential side view of the linear actuator otherwise depicted in FIG. 9 shown being directed into the fully extended configuration such that the main actuator axis of the linear actuator extends at the first oblique angle relative to the reference plane.

FIG. 11 is a first side elevational view of a linear actuator arrangement according to the presently disclosed subject matter showing the linear actuator arrangement in a fully extended configuration with a rod end of a linear actuator of the linear actuator arrangement being positioned at an anchor end of the linear actuator extending intermediate an actuator anchor and a fragmentary movable member extending in parallel relation to a fragmentary station platform.

FIG. 12 is a second side elevational view of the linear actuator arrangement otherwise shown in FIG. 11 showing the linear actuator arrangement in a fully retracted configuration with the fragmentary movable member extending in parallel relation to the fragmentary station platform.

FIG. 13 is a third side elevational view of a linear actuator arrangement coupled to an amusement activity station supported upon a fragmentary station platform, the linear actuator arrangement being depicted in the fully extended configuration.

FIG. 14 is a fourth side elevational view of the linear actuator arrangement otherwise depicted in FIG. 11 as coupled to the amusement activity station otherwise depicted in FIG. 13.

FIG. 15 is a lateral side view of a linear actuator of a linear actuator arrangement according to the presently disclosed subject matter.

FIG. 16 is a perspective view of a linear actuator according to the presently disclosed subject matter showing the linear actuator in a fully extended configuration with a rod end of the linear actuator at an anchor end and extending intermediate an actuator anchor and a fragmentary movable member of a fragmentary amusement activity station.

FIG. 17 is a diagrammatic top view depiction of a linear actuator according to the presently disclosed subject matter showing the linear actuator in a fully extended configuration extending intermediate an actuator anchor and a fragmentary movable member of a fragmentary amusement activity station in electrical communication with a power mechanism.

FIG. 18 is a top plan view of a linear actuator of a linear actuator according to the presently disclosed subject matter.

FIG. 19 is a top plan view of a linear actuator arrangement according to the presently disclosed subject matter shown coupled to an amusement activity station supported by a fragmentary station platform.

FIG. 20 is a first end view of a linear actuator according to the presently disclosed subject matter showing an upper motor housing, a lower main actuator body and rod, and a gear box extending therebetween.

FIG. 21 is a second end view of a linear actuator according to the presently disclosed subject matter showing a gear box end of the linear actuator.

FIG. 22 is a first perspective view of a linear actuator according to the presently disclosed subject matter showing the linear actuator in a fully extended configuration with a rod end of the linear actuator at a displacement end and extending intermediate an actuator anchor and a fragmentary movable member of a fragmentary amusement activity station.

FIG. 23 is a first sequential perspective view of a linear actuator according to the presently disclosed subject matter showing the linear actuator in a fully extended configuration with a rod end of the linear actuator at a displacement end and extending intermediate an actuator anchor and a fragmentary movable member of a fragmentary amusement activity station.

FIG. 24 is a second sequential perspective view of the linear actuator otherwise depicted in FIG. 23 showing the linear actuator in a partially retracted configuration.

FIG. 25 is a third sequential perspective view of the linear actuator otherwise depicted in FIG. 24 showing the linear actuator in a fully retracted configuration.

FIG. 26 is a fourth sequential perspective view of the linear actuator otherwise depicted in FIG. 25 showing the linear actuator in a partially extended configuration.

FIG. 27 is a fifth sequential perspective view of the linear actuator otherwise depicted in FIG. 26 showing the linear actuator returned to the fully extended configuration.

FIG. 28 is a first diagrammatic depiction of an attachment structure extending from a gear box coupled to a diagrammatic member end portion at a displacement end moving through an arcuate movable member path showing relative positions of the displacement end at a fully extended configuration, a partially extended configuration, and fully retracted configuration.

FIG. 29 is a second diagrammatic depiction of a rod end coupled to a diagrammatic member end portion at a displacement end moving through an arcuate movable member path showing relative positions of the displacement end at a fully extended configuration, a partially extended configuration, and fully retracted configuration.

### DETAILED DESCRIPTION OF THE EMBODIMENTS

Referring now to the drawings with more specificity, the following specifications generally describe a linear actuator arrangement for an amusement activity station. One such amusement activity station is exemplified by the amusement activity station otherwise described in US Patent Application Publication No. 2023/0356063 from which this application claims a benefit. Referencing US Patent Application Publication No. 2023/0356063, the reader will there consider an amusement activity station having a reset mechanism exemplified by a powered linear actuator and a movable reset member movably linked to the amusement activity station. Select portions of the amusement activity station otherwise described and illustrated in US Patent Application Publication No. 2023/0356063 are reproduced herein for supporting the presently disclosed subject matter.

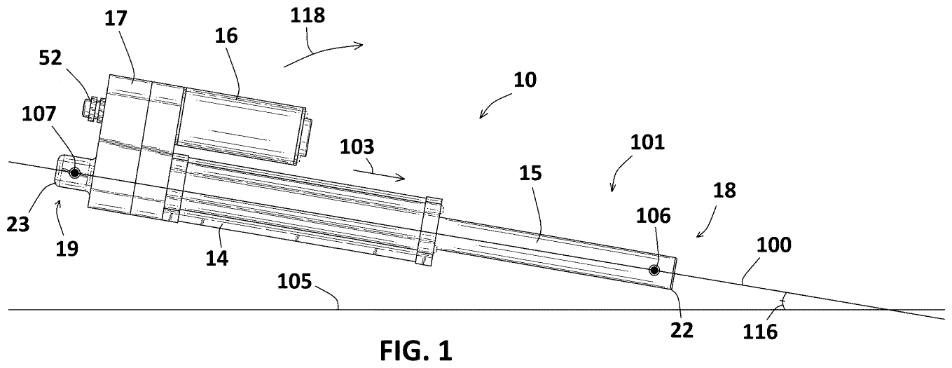

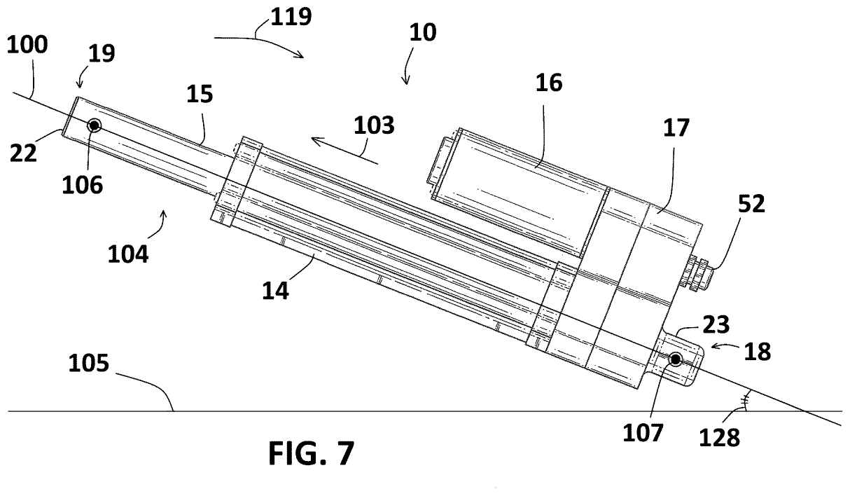

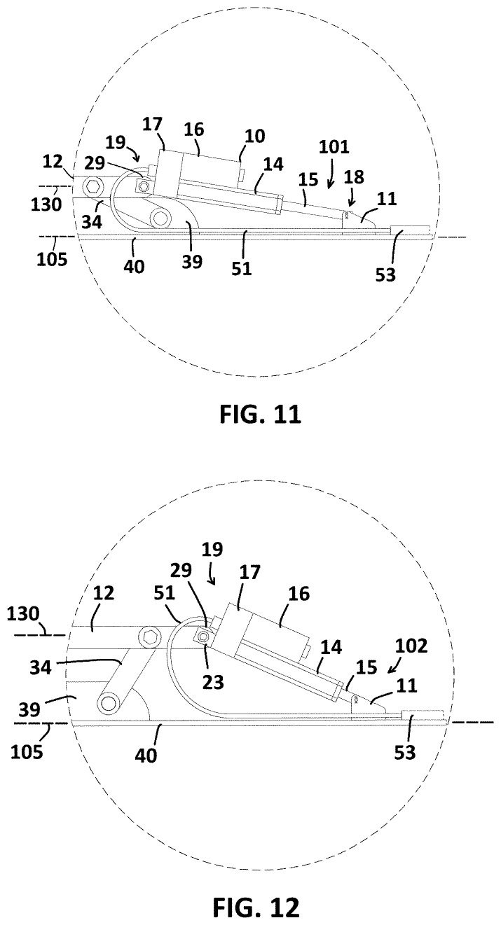

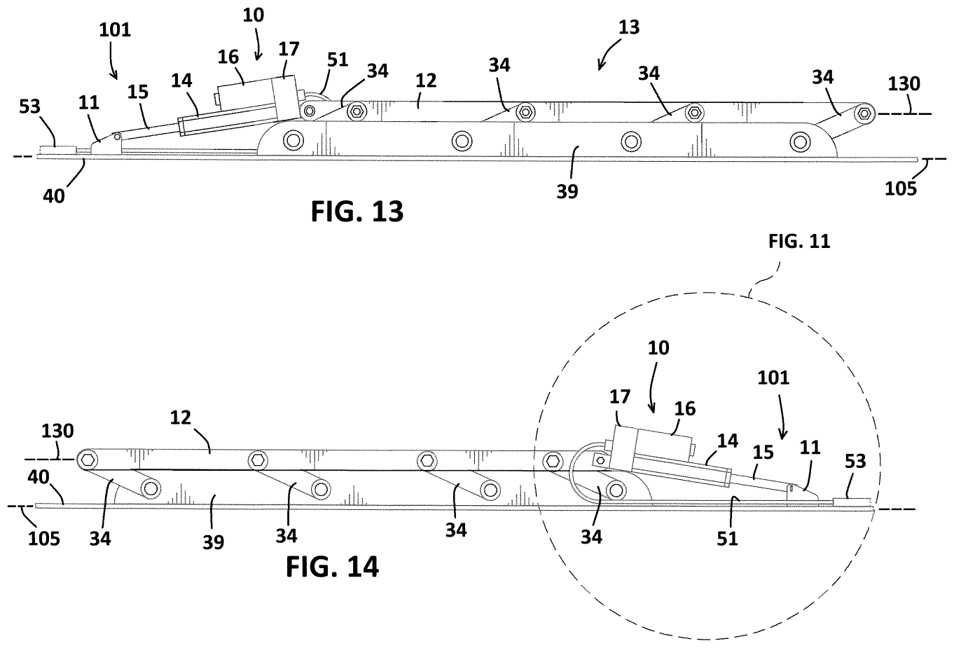

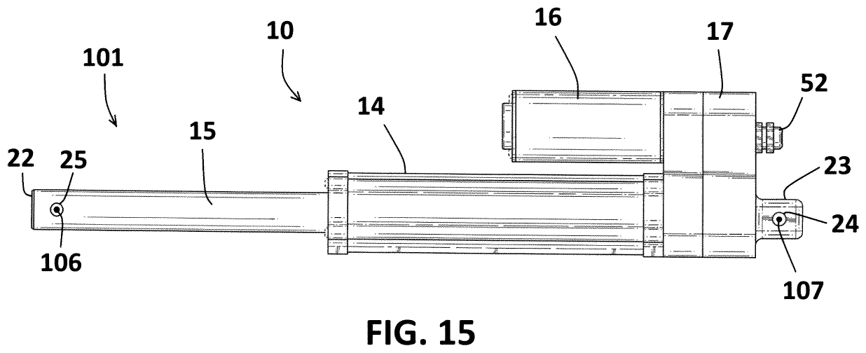

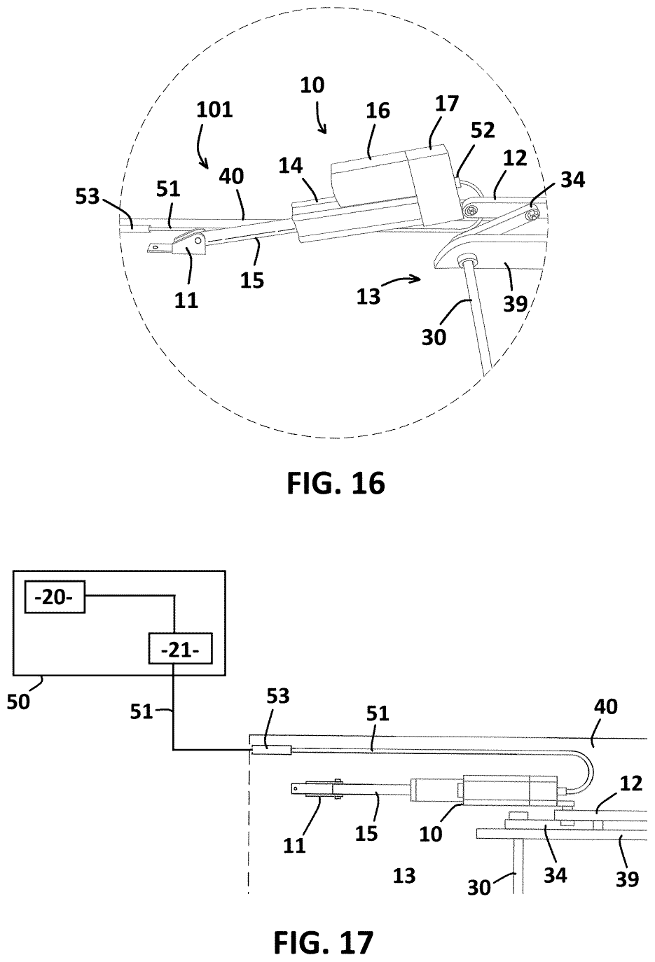

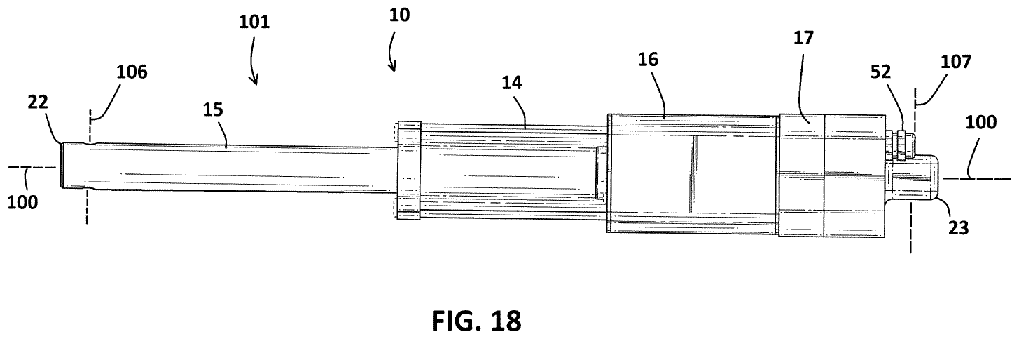

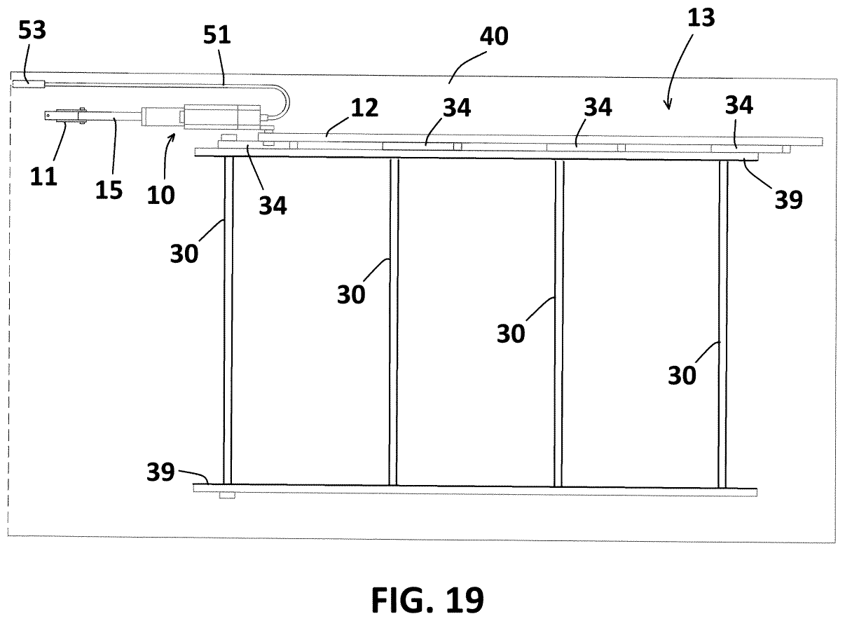

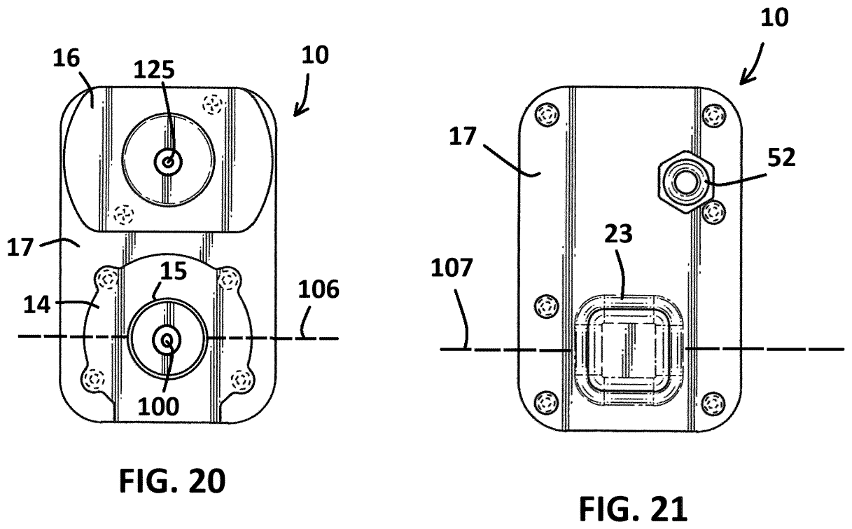

The linear actuator arrangement according to the presently disclosed subject matter comprises a linear actuator as at 10 as introduced and referenced in FIGS. 1-10 and an actuator anchor 11 as introduced and referenced in FIGS. 11-14. In some embodiments, the linear actuator arrangement further comprises a movable member 12 having a main member axis 130 that extends in parallel relation to a reference plane 105. The linear actuator 10 essentially provides an actuation mechanism intermediate the actuator anchor 11 and the movable member 12 of the amusement activity station 13. The linear actuator 10 is pivotally anchored at one end thereof and pivotally free to move along an arcuate path at a second end thereof in some embodiments. In some embodiments, the linear actuator 10 according to the presently disclosed subject matter comprises a main actuator body 14, a rod 15, a motor housing 16, a gear box 17, an anchor end 18 having a fixed pivot axis, a displacement end 19 having a displaceable pivot axis, and a main actuator axis 100.

The main actuator axis 100 extends through the rod 15, the anchor end 18 and the displacement end 19 along the length of the linear actuator 10. In some applications, the linear actuator 10 is in electrical communication with a power mechanism. In some embodiments, the power mechanism is characterized by a power source 20 and a control mechanism 21 at an operator station 50 positioned in spaced relation from the amusement activity station 13 with a power line 51 extending between the power source 20 and control mechanism 21 to the linear actuator 10 as diagrammatically depicted in FIG. 17. The power line 51 may enter the linear actuator 10 via a connector 52 at the exterior of the gear box 17 in some embodiments. In some embodiments, the motor housing 16 and the main actuator body 14 extend from the gear box 17. In some embodiments, the motor housing 16 comprises a main housing axis 125 extending in parallel relation to the main actuator axis 100. In some embodiments, the main housing axis 125 extends in parallel relation to the main actuator axis 100 such that the main actuator axis 100 extends intermediate the main housing axis 125 and a reference plane 105. In other words, in some applications, the linear actuator 10 is positioned intermediate the actuator anchor 11 and the movable member 12 such that the motor housing 16 is positioned opposite a station platform 40 defining the reference plane 105 with the main actuator body 14 extending between the motor housing 16 and the station platform 40.

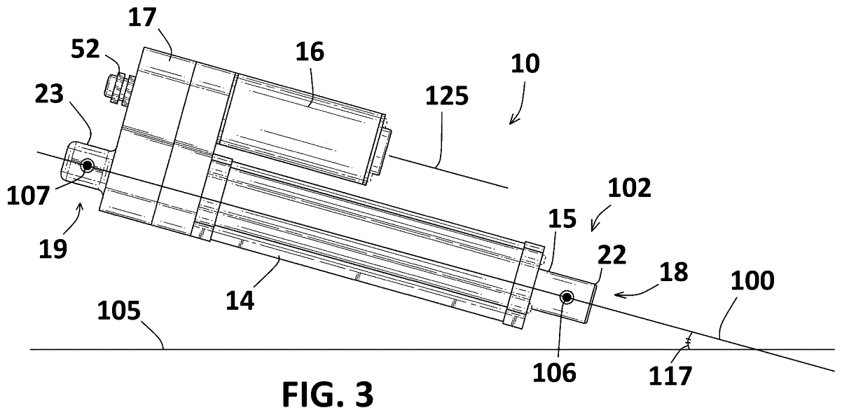

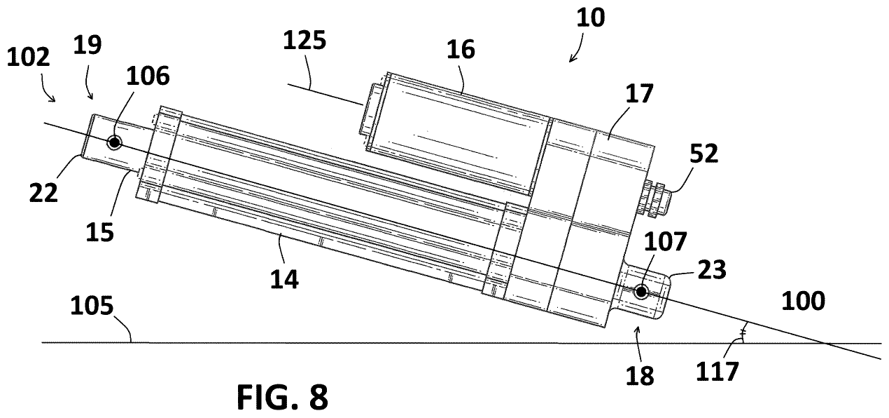

The power source 20 and control mechanism 21 are together operable for selectively delivering power to the linear actuator 10 for extending and retracting the rod 15 relative the main actuator body 14 for moving the displacement end 19 and the movable member 12, as connected to the displacement end 19, relative to the fixed actuator anchor 11. In other words, the power source 20 and control mechanism 21 are together operable to selectively actuate the rod 15 intermediate a fully extended configuration 101 relative to the main actuator body 14 as generally depicted and referenced in FIGS. 1, 5, 6, and 10 and a fully retracted configuration 102 relative to the main actuator body 14 as generally depicted and referenced in FIGS. 3 and 8.

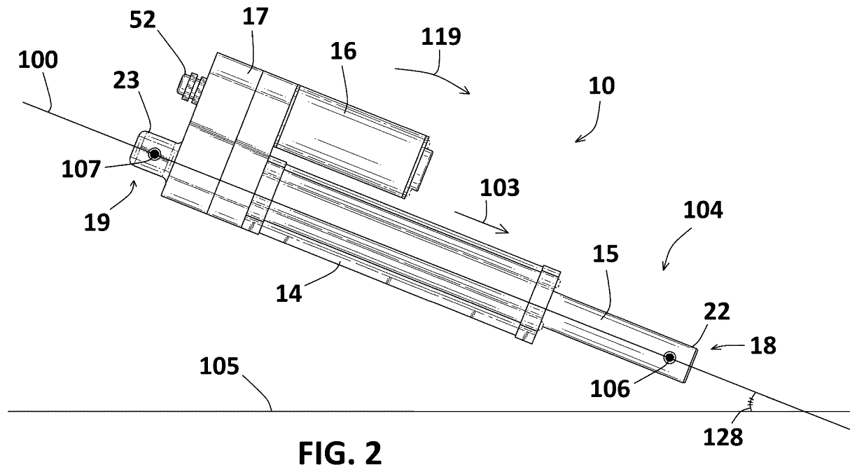

The actuator anchor 11 and the movable member 12 have been removed from FIGS. 1-10 to help the reader better understand the angular relationship of the anchor end 18, the displacement end 19, and the main actuator axis 100 relative to a reference plane 105. Comparatively referencing FIGS. 1-3, the reader will there see the main actuator body 14 being directed as at arrow 103 toward the anchor end 18 such that the rod 15 moves from the fully extended configuration 101 depicted in FIG. 1 to the fully retracted configuration 102 depicted in FIG. 3. FIG. 2 depicts an intermediate, partially extended configuration 104 of the linear actuator 10 wherein the exposed length of the rod 15 is roughly halfway between the fully extended configuration 101 and the fully retracted configuration 102. Comparatively referencing FIGS. 11 and 12, the reader will see the anchor end 18 is fixed by the actuator anchor 11 while the displacement end 19, as coupled to the movable member 12, moves relative to the fixed anchor end 18.

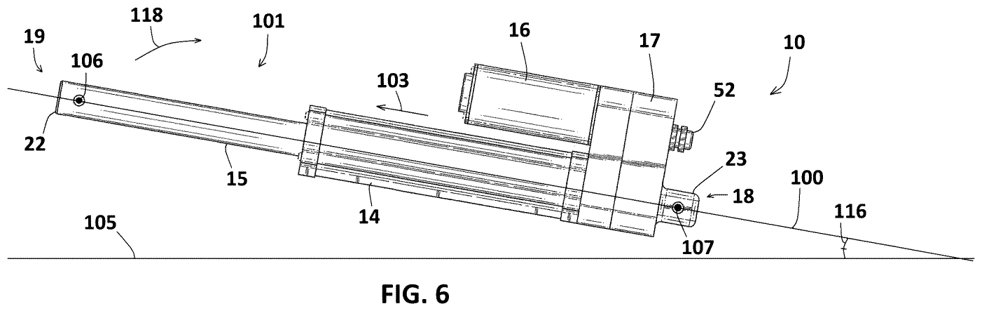

In some embodiments, the displacement end 19 extends from the gear box 17 along the main actuator axis 100. An attachment structure 23 may protrude from the gear box 17 in some embodiments which attachment structure 23 may be positioned at the displacement end 19 while the anchor end 18 is defined by a rod end 22 of the rod 15 as generally depicted in FIGS. 1-5. In some embodiments, the displacement end 19 is conversely defined by the rod end 22 of the rod 15 and the anchor end 18 extends from the attachment structure 23 at the gear box 17 along the main actuator axis 100 as generally depicted in FIGS. 6-10. It will be understood the linear actuator 10 may be inserted intermediate the actuator anchor 11 and the movable member 12 such that either the rod end 22 may be anchored to the actuator anchor 11 or the attachment structure 23 at the gear box 17 may be anchored to the actuator anchor 11.

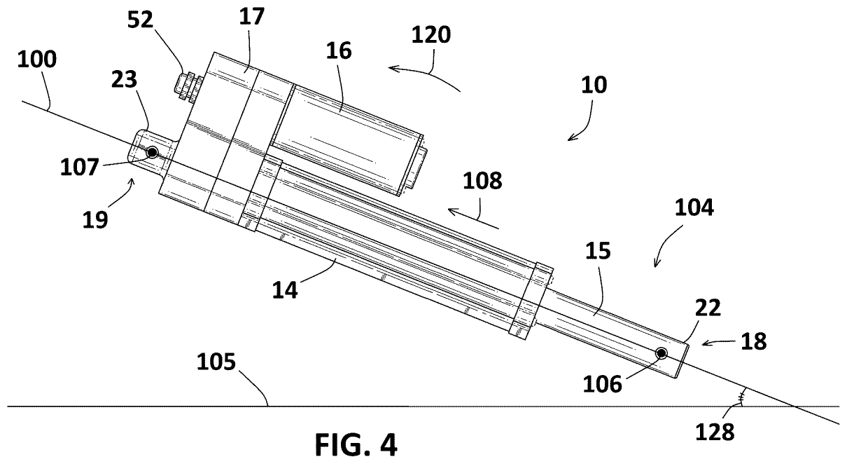

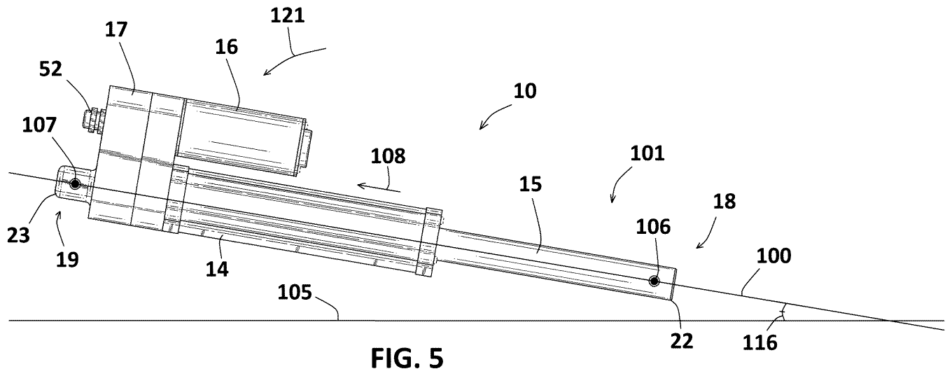

FIGS. 1-3 sequentially depict the process of retracting the rod 15 from the fully extended configuration 101 to the fully retracted configuration 102 in those embodiments wherein the displacement end 19 extends from the gear box 17 along the main actuator axis 100 and the anchor end 18 is defined by the rod end 22 of the rod 15. FIGS. 4-5 sequentially depict the reverse process of extending the rod 15 from the fully retracted configuration 102 to the fully extended configuration 101 whereby the main actuator body 14 is directed at 108 in a direction opposite direction 103 relative to the rod 15.

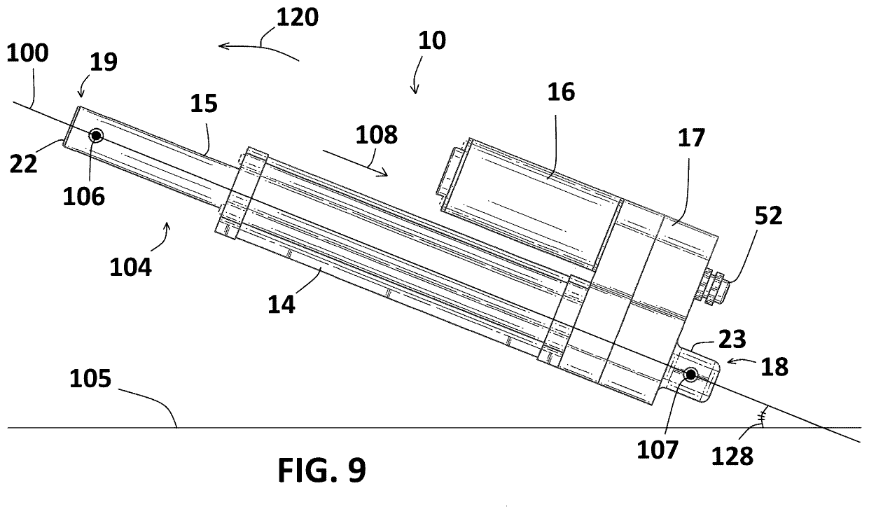

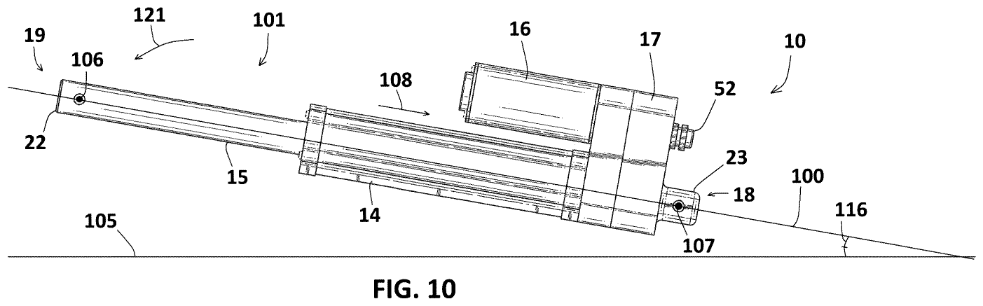

FIGS. 6-8 sequentially depict the process of retracting the rod 15 from the fully extended configuration 101 to the fully retracted configuration 102 in those embodiments wherein the displacement end 19 is defined by the rod end 22 of the rod 15 and the anchor end 18 extends from the gear box 17 along the main actuator axis 100. FIGS. 9-10 sequentially depict the reverse process of extending the rod 15 from the fully retracted configuration 102 to the fully extended configuration 101 whereby the main actuator body 14 is directed at 108 in a direction opposite direction 103 relative to the rod 15.

In some embodiments, the attachment structure 23 comprises a bore or through-hole 24 for receiving a connecting pin. Similarly, the rod end 22 comprises a bore or through-hole 25 for receiving a connecting pin. The bore 25 extends orthogonally relative to the main actuator axis 100 for defining a first axis of rotation 106 and the bore 24 extends orthogonally relative to the main actuator axis 100 for defining a second axis of rotation 107. The axes of rotation 106 and 107 extend into the page in FIGS. 1-10. Either the axis of rotation 106 or the axis of rotation 107 may be positioned at the anchor end 18 such that the select axis of rotation is fixed in parallel relation to the reference plane 105 via the actuator anchor 11.

In other words, the anchor end 18 is attached to the actuator anchor 11 thereby fixing a first axis of rotation as exemplified by either axis of rotation 106 or axis of rotation 107 extending through the anchor end 18 orthogonal to the main actuator axis 100 in parallel relation to the reference plane 105. In some embodiments, the reference plane 105 may be defined by a planar station platform 40 to which the actuator anchor 11 is fastened and upon which the amusement activity station 13 is supported. In other words, in some embodiments, the reference plane 105 extends through the planar station platform 40 and the movable member 12 of the amusement activity station 13, as supported by the station platform 40, moves in parallel relation to the station platform 40.

The displacement end 19 is coupled to the movable member 12 for directing the movable member 12 along a movable member path 110 intermediate the fully extended configuration 101 and the fully retracted configuration 102 such that the main member axis 130 remains parallel to the reference plane 105 as comparatively depicted in FIGS. 11 and 12. The displacement end 19 comprises a second axis of rotation as exemplified by either axis of rotation 106 or axis of rotation 107 extending orthogonally relative to the main actuator axis 100 in parallel relation to the reference plane 101 and is translatable along the movable member path 110.

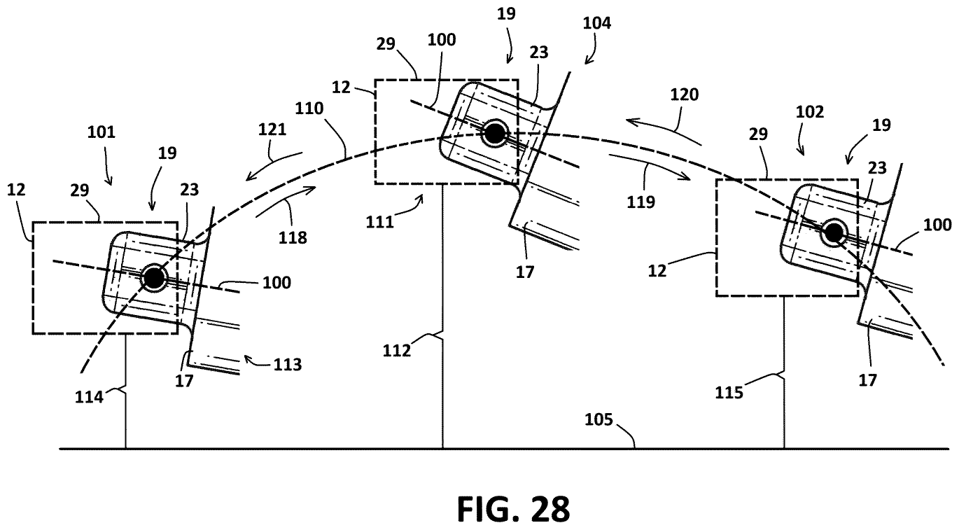

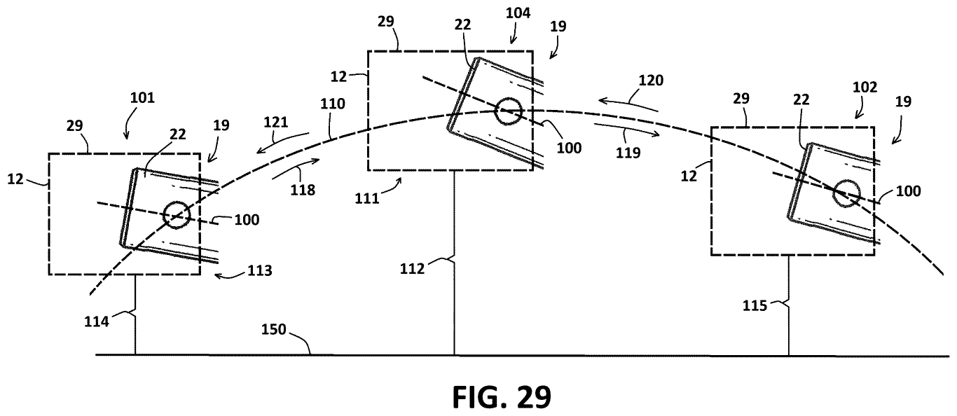

Comparatively referencing FIGS. 28 and 29, the reader will there consider the movable member path 110 diagrammatically there depicted. FIG. 28 depicts a diagrammatic member end portion 29 of the movable member 12 as attached to the displacement end 19 characterized by the attachment portion 23 of the gear box 13 and FIG. 29 depicts a diagrammatic member end portion 29 of the movable member 12 as attached to the displacement end 19 characterized by the rod end 22 of the rod 15. In some embodiments, the movable member path 110 is arcuate such that the displacement end 19 moves through an arc length terminally defined by the fully extended configuration 101 and the fully retracted configuration 102. In some embodiments, the arc length comprises an arc length high point as at 111.

The arc length high point 111 is maximally distanced from the reference plane 105 as at maximum distance 112 as compared to the positions of the member end portion 29 and the displacement end 19 when at the fully extended configuration 101 and the fully retracted configuration 102. An arc length low point 113 is located at the fully extended configuration 101 as at minimum distance 114 relative to the reference plane 105. The member end portion 29 and displacement end 19 are located intermediate the arc length high point 111 and arc length low point 113 at an intermediate distance 115 relative to the reference plane 105 when in the fully retracted configuration 102. The intermediate distance 115 is less than the maximum distance 112 and greater than the minimum distance 114 in some embodiments.

In some embodiments, the fully extended configuration 101 obliquely angles the main actuator axis 100 relative to the reference plane 105 at a first oblique angle 116 and the fully retracted configuration 102 obliquely angles the main actuator axis 100 relative to the reference plane 105 at a second oblique angle 117 greater than the first oblique angle 116. In the illustrated examples, the first oblique angle is on the order of 10 degrees and the second oblique angle is on the order of 15 degrees. These degree examples are exemplary only and should not be construed as limiting. The minimum distance 114 at the arc length low point 113 corresponds with the first oblique angle 116 and the intermediate distance 115 corresponds with the second oblique angle 117.

In some embodiments, the arc length high point 111 is maximally distanced from the reference plane 105 such that a partially extended configuration 104 of the rod 15 relative to the main actuator body 14 obliquely angles the main actuator axis 100 relative to the reference plane 105 at a third oblique angle 128 greater than second oblique angle 117. In the illustrated examples, the third oblique angle is on the order of 20 degrees. Stated another way, in the illustrated examples, the main actuator axis 100 may be obliquely angled 10 degrees from the reference plane 105 when in the fully extended configuration 101. As the rod 15 is retracted into the main actuator body 14, the main actuator axis 100 becomes angled 20 degrees from the reference plane 105 at the arc length high point 111, and as the rod 15 is fully retracted into the main actuator body 14, the main actuator axis becomes angle 15 degrees from the reference plane 105. These degree examples are exemplary only and should not be construed as limiting.

The movable member path 110 starts at a point closest to the reference plane 105 when at the fully extended configuration 101 and incrementally increases in distance from the reference plane 105 toward the arc length high point 111 as the movable member 12 moves in a first upslope direction 118 along the movable member path 110. Thereafter, the movable member 12 incrementally decreases in distance from the arc length high point 111 relative to the reference plane 105 as the movable member 12 moves in a downslope direction 119 toward the fully retracted configuration 102. When in the fully retracted configuration 102, the distance 115 of the movable member 12 from the reference plane 105 is between the minimum distance 114 and the maximum distance 112. When reverting back to the fully extended configuration 101 from the fully retracted configuration 102, the movable member 12 similarly follows the movable member path 110 in a reverse upslope direction 120 to the arc length high point 111 and thereafter in a downslope direction 121 to the arc length low point 113.

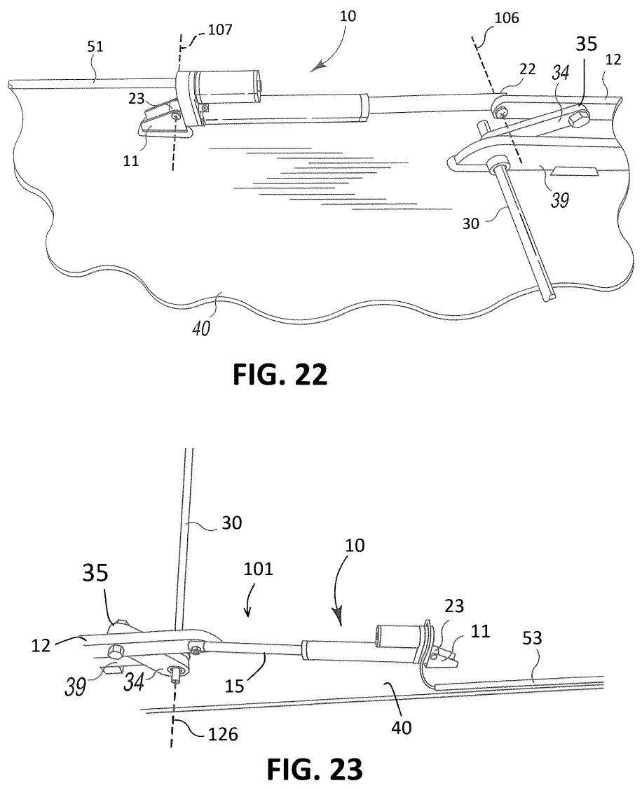

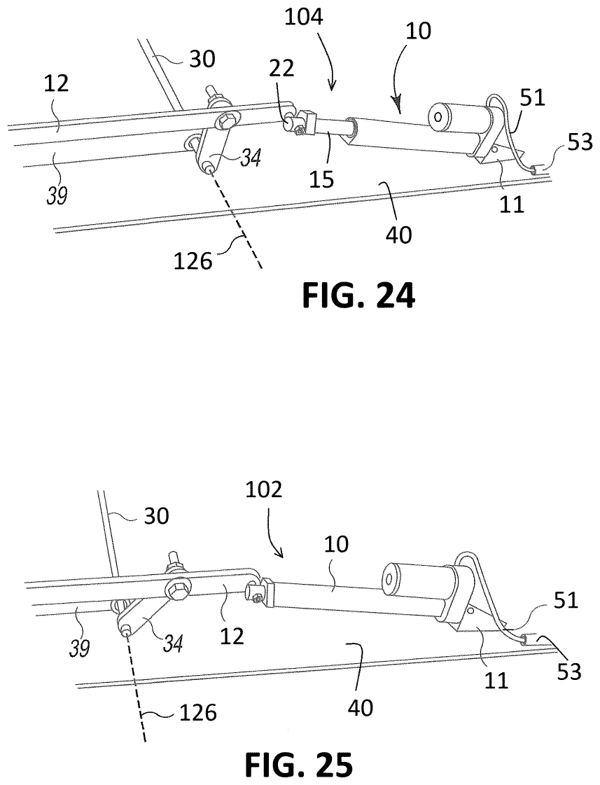

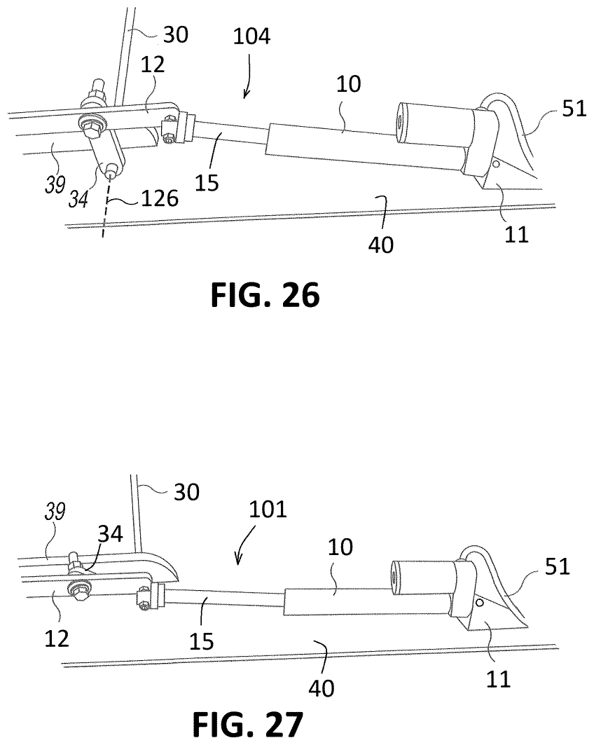

In some embodiments, the amusement activity station 13 may further comprise an anchor member 39 and at least one linkage member 34 movably linking the movable member 12 to the anchor member 39. In some embodiments, a plurality of linkage members 34 movably link the movable member 12 to the anchor member 39. In some embodiments, each linkage member 34 of the plurality of linkage members 34 comprises a uniform linkage length and a linkage end 35 as referenced in FIGS. 22 and 23. In some embodiments, each linkage end 35 is translatable along a linkage end path substantially equivalent to the movable member path 110 in spaced relation thereto along the main member axis 130. In some embodiments, the linkage length defines the arc length high point 111.

In some embodiments, the movable member 12 is configured to provide a reset mechanism linkage. When the movable member 12 is directed along the movable member path 110 as at upslope direction 118 and downslope direction 119 into the fully retracted configuration 102, the linear actuator 10, anchor member 11, and movable member 12 operate to reset the amusement activity station 13. When the movable member 12 is re-directed along the movable member path 110 as at upslope direction 120 and downslope direction 121 into the fully extended configuration 101, the linear actuator 10, anchor member 11, and movable member 12 enable use of the amusement activity station 13.

In other words, in some applications, the linear actuator arrangement according to the presently disclosed subject matter provides a basis for a reset mechanism. In the case of the amusement activity station made the subject of US Patent Application Publication No. 2023/0356063, the reset mechanism is configured to reset the series of secondary target objects from the substantially horizontal fallen position to the substantially vertical upright position. The reset mechanism is cooperable with a series of pivot rods as at 30 of the amusement activity station 13. The exemplary reset mechanism according to the presently disclosed subject matter may be characterized by the linear actuator 10 and the movable member 12 where the anchor end 18 of the linear actuator 10 is anchored to the actuator anchor 11. The linear actuator 10 is pivotally coupled to the member end portion 29 of the movable member 12 and is operable to essentially linearly actuate the movable member 12 in back and forth or to and fro movements through the movable member path 110 as defined hereinabove.

More particularly, the linear actuator 10 is pivotally coupled to the movable member 12 at the member end portion 29 with the first axis of rotation or pivot axis 106 extending through the coupling or attachment site as generally depicted in FIG. 22. The movable member 12 is also attached to each of the pivot members 30 by way of linkage members 34. The linkage members 34 are each preferably dimensioned for cooperating with a maximum linear actuation state at the fully extended configuration 101 and a minimum linear actuation state at the fully retracted configuration 102 for pivoting the pivot members 30 through a reset angle of 90 degrees in some applications. The linear actuator 10 further comprises anchor end 18 pivotally coupled to the actuator anchor 11 exemplified by a bracket with the second axis of rotation 107 or second pivot axis extending through the attachment site. The anchor end 18 and the displacement end 19 are pivotally coupled to opposed structure for enabling the linear actuator 10 to pivot as necessary during reset movements of the reset mechanism.

The movable member 12 may be linked to laterally opposed anchor members as at 39 by way of the linkage members and the pivot members 30. The laterally opposed anchor members 39 are affixed to the station platform 40 and pivotally receive each pivot member 30. The station platform 40 and laterally opposed anchor members 39 together function to help fix the pivot axes 126 extending through each pivot member 30 relative to the reference plane 105 defined by the station platform 40 in some applications. The station platform 40 may be further preferably fixedly attached to an underlying platform support surface thereby fixing the amusement activity station 13 to the underlying anchor support surface. In this last regard, it is contemplated that the station platform 40 may be bolted to the underlying anchor support surface.

While the above descriptions contain much specificity, this specificity should not be construed as limitations on the scope of the presently disclosed subject matter, but rather as an exemplification thereof. The foregoing embodiments illustrate the principles, preferred or example embodiments, and modes of assembly and operation, of the presently disclosed subject matter. It is noted, however, the presently disclosed subject matter is not, and shall not be construed as being exclusive or limited to the specific or particular embodiments herein.

Accordingly, all embodiments herein should be regarded as illustrative rather than exclusive or limiting, and variations to embodiments herein may be made without departing from the scope of the presently disclosed subject matter. In other words, although the linear actuator arrangements according to the presently disclosed subject matter have been described by reference to a number of different embodiments, it is not intended that the novel combinations or assemblies be limited thereby, but that modifications thereof are intended to be included as falling within the broad scope and spirit of the foregoing disclosure, the appended drawings, and the following claims.

What is claimed is:

1. A linear actuator arrangement for an amusement activity station, the linear actuator arrangement comprising:
a linear actuator, the linear actuator comprising a main actuator body, a rod, an anchor end, a displacement end, a main actuator axis, and a power mechanism;
the main actuator axis extending through the rod, the anchor end and displacement end, the power mechanism for selectively actuating the rod intermediate a fully extended configuration and a fully retracted configuration relative to the main actuator body; and
an actuator anchor attached to the anchor end thereby fixing a first axis of rotation extending through the anchor end orthogonal to the main actuator axis in parallel relation to a reference plane; and
a movable member, the movable member comprising a main member axis, the main member axis extending parallel to the reference plane;
the displacement end being coupled to the movable member for directing the movable member along a movable member path intermediate the fully extended and fully retracted configurations;
the displacement end comprising a second axis of rotation extending orthogonally relative to the main actuator axis in parallel relation to the reference plane and translatable along the movable member path.

2. The linear actuator arrangement according to claim 1, wherein the fully extended configuration obliquely angles the main actuator axis relative to the reference plane at a first oblique angle, the fully retracted configuration obliquely angling the main actuator axis to the reference plane at a second oblique angle greater than the first oblique angle.

3. The linear actuator arrangement according to claim 2, wherein the movable member path is arcuate such that the displacement end moves through an arc length.

4. The linear actuator arrangement according to claim 3, wherein the arc length comprises an arc length high point, the arc length high point being maximally distanced from the reference plane such that a partially extended configuration of the rod relative to the main actuator body obliquely angles the main actuator axis relative to the reference plane at a third oblique angle, the third oblique angle being greater than second oblique angle.

5. The linear actuator arrangement according to claim 1, wherein the linear actuator comprises a motor housing and a gear box attached to the motor housing and the main actuator body, the motor housing comprising a main housing axis extending in parallel relation to the main actuator axis.

6. The linear actuator arrangement according to claim 5, wherein the main housing axis extends in parallel relation to the main actuator axis such that the main actuator axis extends intermediate the main housing axis and the reference plane.

7. The linear actuator arrangement according to claim 6, wherein the displacement end extends from the gear box and the anchor end is defined by a rod end of the rod.

8. The linear actuator arrangement according to claim 6, wherein the displacement end is defined by a rod end of the rod and the anchor end extends from the gear box.

9. The linear actuator arrangement according to claim 4, wherein the movable member is linked to a reset mechanism of the amusement activity station, the fully retracted configuration for resetting the amusement activity station, the fully extended configuration enabling use of the amusement activity station.

10. The linear actuator arrangement according to claim 9, wherein the movable member is linked to an anchor member of the amusement activity station by at least one linkage member, the linkage member having a linkage end, the linkage end being translatable along the movable member path.

11. A linear actuator arrangement for an amusement activity station having a movable member, the linear actuator arrangement comprising:
a linear actuator, the linear actuator comprising a main actuator body, a rod, an anchor end, a displacement end, and a main actuator axis;
the main actuator axis extending through the rod, the anchor end and displacement end, the rod being actuable intermediate a fully extended configuration and a fully retracted configuration relative to the main actuator body;
an actuator anchor attached to the anchor end thereby fixing a first axis of rotation extending through the anchor end orthogonal to the main actuator axis in parallel relation to a reference plane;
the displacement end being coupled to the movable member for directing the movable member along a movable member path intermediate the fully extended and fully retracted configurations;
the displacement end comprising a second axis of rotation extending orthogonally relative to the main actuator axis in parallel relation to the reference plane and translatable along the movable member path.

12. The linear actuator arrangement according to claim 11, wherein the fully extended configuration obliquely angles the main actuator axis relative to the reference plane at a first oblique angle, the fully retracted configuration obliquely angling the main actuator axis to the reference plane at a second oblique angle greater than the first oblique angle.

13. The linear actuator arrangement according to claim 12, wherein the movable member path is arcuate such that the displacement end moves through an arc length.

14. The linear actuator arrangement according to claim 13, wherein the arc length comprises an arc length high point, the arc length high point being maximally distanced from the reference plane such that a partially extended configuration of the rod relative to the main actuator body obliquely angles the main actuator axis relative to the reference plane at a third oblique angle, the third oblique angle being greater than second oblique angle.

15. The linear actuator arrangement according to claim 11, wherein the linear actuator comprises a motor housing and a gear box attached to the motor housing and the main actuator body, the motor housing comprising a main housing axis extending in parallel relation to the main actuator axis.

16. The linear actuator arrangement according to claim 15, wherein the main housing axis extends in parallel relation to the main actuator axis such that the main actuator axis extends intermediate the main housing axis and the reference plane.

17. The linear actuator arrangement according to claim 11, wherein the displacement end extends from the main actuator body along the main actuator axis and the anchor end is defined by a rod end of the rod.

18. The linear actuator arrangement according to claim 11, wherein the displacement end is defined by a rod end of the rod and the anchor end extends from the main actuator body along the main actuator axis.

19. The linear actuator arrangement according to claim 11, wherein the movable member is linked to a reset mechanism of the amusement activity station, the fully retracted configuration for resetting the amusement activity station, the fully extended configuration enabling use of the amusement activity station.

20. The linear actuator arrangement according to claim 19, wherein the movable member is linked to an anchor member of the amusement activity station by at least one linkage member, the linkage member having a linkage end, the linkage end being translatable along the movable member path.
